(19) United States
(12) Patent Application Publication
(10) Pub. No.: US 2025/0130204 A1
(43) Pub. Date: Apr. 24, 2025

(54) SPRING HEALTH MONITOR FOR SPRING ACTUATED TOOLS, METHOD, AND SYSTEM

(71) Applicant: Baker Hughes Oilfield Operations LLC, Houston, TX (US)

(72) Inventor: Darin Duphorne, Houston, TX (US)

(21) Appl. No.: 18/489,657

(22) Filed: Oct. 18, 2023

(51) Int. Cl. G01N 29/14; E21B 47/01

(52) U.S. Cl. CPC G01N 29/14; E21B 34/06; G01H 1/14; E21B 2200/05; G01N 2291/023

(57) ABSTRACT

A spring actuated tool including a functional component, a spring in contact with the functional component, an acoustic sensor disposed in acoustic proximity to the spring, the acoustic sensor monitoring the spring for acoustic signals generated during spring deformation. A spring health monitor for a spring actuated tool including an acoustic sensor in acoustic communication with a spring of the spring actuated tool, the acoustic sensor configured to monitor the spring for acoustic signals generated during spring deformation, a communication arrangement communicatively connecting the sensor to an information destination. A method for managing a tool having an actuation spring, including monitoring sounds emitted from the spring during movement of the spring. A borehole system including a borehole in a subsurface formation, a string in the borehole, a spring actuated tool disposed within or as a part of the string.

### BACKGROUND

In many industries, including downhole industries related to resource recovery and fluid sequestration, springs are used to actuate functions in many types of tools. Particularly in tools where actuation is periodic and repeated, spring can suffer cyclic fatigue failures over time. In general, tools either fail and are repaired or replaced when a cyclic failure occurs or may be repaired or replaced on a schedule to prevent unexpected downtime of the tool. The former expects inopportune down times and the latter which avoiding those indignancies increases costs by replacing and or repairing tools prior to their actual need. Efficiency and reliability are always paramount and accordingly the art would well receive alternatives that achieve the benefits of both of the above paradigms.

### SUMMARY

An embodiment of a spring actuated tool including a functional component, a spring in operative contact with the functional component, an acoustic sensor disposed in acoustic proximity to the spring, the acoustic sensor configured to monitor the spring for acoustic signals generated during spring deformation.

An embodiment of a spring health monitor for a spring actuated tool including an acoustic sensor in acoustic communication with a spring of the spring actuated tool, the acoustic sensor configured to monitor the spring for acoustic signals generated during spring deformation, a communication arrangement communicatively connecting the sensor to an information destination.

An embodiment of a method for managing a tool having an actuation spring, including monitoring sounds emitted from the spring during movement of the spring.

An embodiment of a borehole system including a borehole in a subsurface formation, a string in the borehole, a spring actuated tool disposed within or as a part of the string, a spring health monitor disposed in acoustic proximity with the spring of the tool.

### BRIEF DESCRIPTION OF THE DRAWINGS

The following descriptions should not be considered limiting in any way. With reference to the accompanying drawings, like elements are numbered alike:

FIG. 1 is a schematic view of a spring actuated tool illustrating various embodiments of sensor location for monitoring health of the spring of the tool; and

FIG. 2 is a view of a borehole system including a spring health monitoring configuration as disclosed herein.

### DETAILED DESCRIPTION

A detailed description of one or more embodiments of the disclosed apparatus and method are presented herein by way of exemplification and not limitation with reference to the Figures.

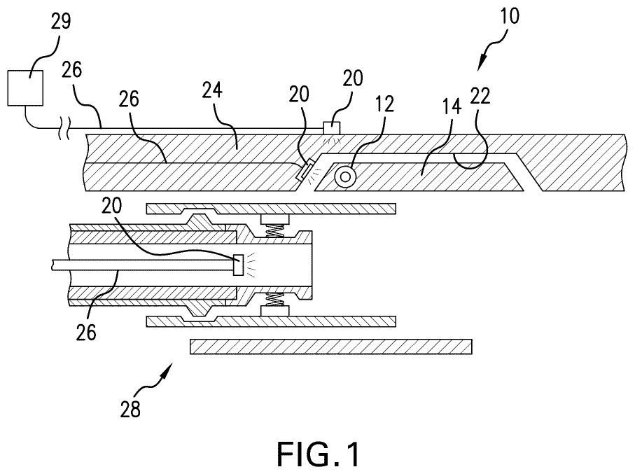

Referring to FIG. 1, a spring actuated tool 10 is illustrated. The tool 10 includes a spring 12 in operative contact with a functional component 14 of the tool 10. The functional component 14 may be a flow tube, a flapper, a sleeve, a valve, or any other component of a tool that does something and is affected in some way by the spring 12. “Affected in some way” means that the component 14 is initially activated or moved by the spring 12 or that the component 14 is inactivated or subject to return movement by the spring 12 after the activation, such as, for example, returning a component to its resting position after an activation. In one example, as illustrated in FIG. 1, the spring 12 is a torsion spring and the functional component 14 is a flapper, where the tool 10 is a safety valve, though it is to be appreciated that this is but one example and other systems having the structure described above are contemplated. Further included in FIG. 1 is a sensor 20, that may be an acoustic sensor. The sensor 20 is positioned in acoustic communication with the spring 12 so that the sensor may “hear” sounds emanating from the spring 12 during movement thereof. Such sounds may be characterized as creaking, squeaking, popping, groaning, etc. when the spring 12 is asked to change its shape and/or length during the course of its normal operation. The sensor 20 may be disposed in a chamber 22 of a housing 24 wherein the spring 12 is located or may be outside of the chamber 22 providing the sensor 20 is still in acoustic communication with the spring 12. In some embodiments the sensor 12 may be supported by the housing 24. In some cases, the sensor may be in acoustic communication through vibration transmitted through the housing 24 and hence it is to be understood that the sensor need not be in fluid communication with the spring 12. Finally, it is also contemplated that the sensor 20 may be mounted to a string run into the tool 10 later such as a coiled tubing string, slickline, wireline, etc. In embodiments, this may be on a shifting tool so that the sensor 20 will be in acoustic communication with the spring 12 during the shifting of the functional component 14, and therefore able to hear what sounds are made by spring 12. It will be appreciated that three sensors 20 are illustrated in FIG. 1. These may be alternative placements of the sensor 20 or may be used collectively in sub groups or all at once in some embodiments. The sensed sounds may be immediately compared to a database of sounds, recorded for comparison with a database of sounds at a subsequent time, entered into a comparator or signal processing circuit, etc. Further, the sensed sounds may not be entered into a circuit or database at all but rather merely monitored for a change. Change in sound is likely a harbinger of something and therefore provides valuable information to an operator even in such an unsophisticated form as a light on a console that illuminates when a sound changes. The sensor 20 may be tethered by a communication arrangement 26 to an information destination 29 such as, for example, a remote processor or recorder or user interface or combinations including at least one of these. Communication arrangement 26 include tethers such as an electric line, an optical line, hydraulic line, or may be a wireless communication configuration.

In any event, the sensed sounds from spring 12 will be compared to the database of sounds to determine the relative health of the spring 12. The database of sounds is to be a comprehensive database that contains many sounds made by springs of the same type over their lifetimes, those sounds changing depending upon where in the lifecycle a particular spring happens to be or caused by any other deleterious condition. For example, conditions such as a material defect or failure caused by stress or damage regardless of whether that defect originates from cycling, contact or impact from objects, hydrogen embrittlement, corrosion, etc., all affect sounds made by the spring 12. For example, a spring 12 might be nearing the end of its useful life or has suffered an insult and hence is emanating sounds that are at a lower frequency than the sounds a spring of that type would emanate at a beginning of its lifecycle or prior to that insult. Comparing the sounds made to the database would alert a user, a processor with or without a memory and in some embodiments including an algorithm to do the comparing, Artificial Intelligence, an alarm beacon, etc., that the spring is closing on its end of life and some action should be planned to repair or replace the tool 10. Because the information can be obtained either periodically or continuously over the use period of the tool 10, decision makers can be kept apprised of the spring condition long in advance of a critical failure date. Longer service lives of tools 10 can be obtained because premature repair or replacement will be unnecessary when using the spring health monitoring disclosed herein.

The method includes the use of a spring health monitor 28 that comprises the sensor 20 mounted to the tool 10 or conveyed to the tool 10, the communication arrangement 26 and the information destination 19. The method includes collecting sounds registered by the sensor if the sensor is resident with the tool 10 and includes first running the sensor 20 if not resident with the tool 10. Once the sounds are collected or in real time, the sounds are compared locally or remotely with the database of sounds. Finally, decisions may be made about actions to be taken either automatically by the processor, whether AI is used or not or by a user.

In an embodiment, it is possible to use the database to also determine the type of spring 12 that is being queried. Hence, with a sensor on a string that is after run, the same sensor may be used to query any spring 12 in the downhole environment and determine type of spring and also expected stage of life for that spring.

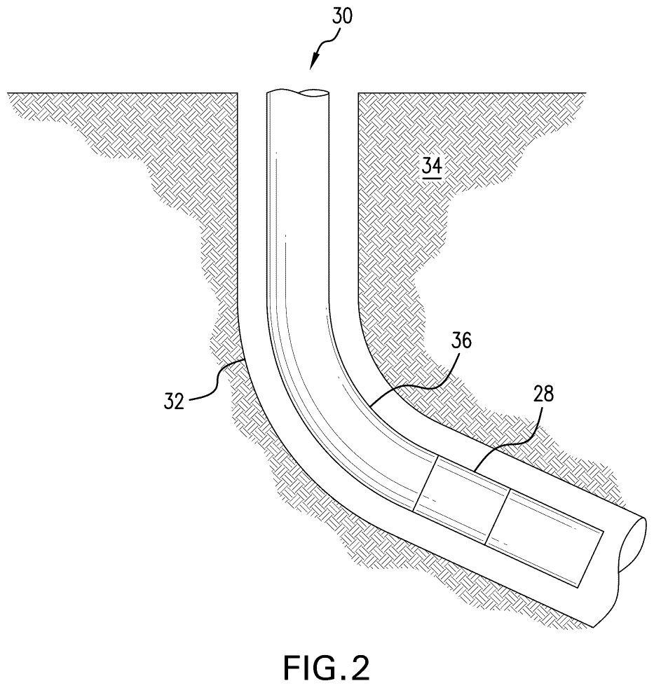

Referring to FIG. 2, a borehole system 30 is illustrated. The system 30 comprises a borehole 32 in a subsurface formation 34. A string 36 is disposed within the borehole 32. A spring health monitoring configuration 28 as disclosed herein is disposed within or as a part of the string 36.

Set forth below are some embodiments of the foregoing disclosure:
Embodiment 1: A spring actuated tool including a functional component, a spring in operative contact with the functional component, an acoustic sensor disposed in acoustic proximity to the spring, the acoustic sensor configured to monitor the spring for acoustic signals generated during spring deformation.
Embodiment 2: The tool as in any prior embodiment, wherein the spring is disposed in a chamber of a housing of the tool.
Embodiment 3: The tool as in any prior embodiment wherein the sensor is disposed in the chamber.
Embodiment 4: The tool as in any prior embodiment wherein the sensor is supported by the housing.
Embodiment 5: The tool as in any prior embodiment, wherein the spring is a torsion spring.
Embodiment 6: The tool as in any prior embodiment, wherein the tool is a safety valve.
Embodiment 7: A spring health monitor for a spring actuated tool including an acoustic sensor in acoustic communication with a spring of the spring actuated tool, the acoustic sensor configured to monitor the spring for acoustic signals generated during spring deformation, a communication arrangement communicatively connecting the sensor to an information destination.
Embodiment 8: The tool as in any prior embodiment, wherein the destination is a user interface.
Embodiment 9: The tool as in any prior embodiment, wherein the destination is a memory.
Embodiment 10: The tool as in any prior embodiment, wherein the destination further includes an algorithm configured to compare acoustic signals received by the sensor to a database.
Embodiment 11: The tool as in any prior embodiment, wherein the destination includes artificial intelligence.
Embodiment 12: The tool as in any prior embodiment, wherein the communication arrangement is a tether.
Embodiment 13: The tool as in any prior embodiment, wherein the communication arrangement is wireless.
Embodiment 14: The tool as in any prior embodiment, wherein the tool is configured to mount on one of a coiled tubing string, slick line, or wireline.
Embodiment 15: A method for managing a tool having an actuation spring, including monitoring sounds emitted from the spring during movement of the spring.
Embodiment 16: The method as in any prior embodiment, further including conveying the sounds to a circuit, the circuit processing the sounds for variation.
Embodiment 17: The method as in any prior embodiment, further comprising comparing the sounds emitted with a database of sounds made by springs in tools having actuation springs, and generating an estimated condition of the spring based upon the comparing.
Embodiment 18: The method as in any prior embodiment, further including moving an acoustic sensor into acoustic proximity with the spring.
Embodiment 19: The method as in any prior embodiment wherein the moving is running the acoustic sensor in a borehole.
Embodiment 20: The method as in any prior embodiment, further including operating an artificial intelligence processor to support the comparing.
Embodiment 21: The method as in any prior embodiment, further including making a decision on when to replace or repair the tool based upon the generating.
Embodiment 22: A borehole system including a borehole in a subsurface formation, a string in the borehole, a spring actuated tool disposed within or as a part of the string, a spring health monitor as in any prior embodiment disposed in acoustic proximity with the spring of the tool.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of +8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A spring actuated tool comprising:
a functional component;
a spring in operative contact with the functional component;
an acoustic sensor disposed in acoustic proximity to the spring, the acoustic sensor configured to monitor the spring for acoustic signals generated during spring deformation.

2. The tool as claimed in claim 1, wherein the spring is disposed in a chamber of a housing of the tool.

3. The tool as claimed in claim 2 wherein the sensor is disposed in the chamber.

4. The tool as claimed in claim 2 wherein the sensor is supported by the housing.

5. The tool as claimed in claim 1, wherein the spring is a torsion spring.

6. The tool as claimed in claim 1, wherein the tool is a safety valve.

7. A spring health monitor for a spring actuated tool comprising:
an acoustic sensor in acoustic communication with a spring of the spring actuated tool, the acoustic sensor configured to monitor the spring for acoustic signals generated during spring deformation;
a communication arrangement communicatively connecting the sensor to an information destination.

8. The tool as claimed in claim 7, wherein the destination is a user interface.

9. The tool as claimed in claim 7, wherein the destination is a memory.

10. The tool as claimed in claim 7, wherein the destination further includes an algorithm configured to compare acoustic signals received by the sensor to a database.

11. The tool as claimed in claim 10, wherein the destination includes artificial intelligence.

12. The tool as claimed in claim 7, wherein the communication arrangement is a tether.

13. The tool as claimed in claim 7, wherein the communication arrangement is wireless.

14. The tool as claimed in claim 7, wherein the tool is configured to mount on one of a coiled tubing string, slick line, or wireline.

15. A method for managing a tool having an actuation spring, comprising:
monitoring sounds emitted from the spring during movement of the spring.

16. The method as claimed in claim 15, further including conveying the sounds to a circuit, the circuit processing the sounds for variation.

17. The method as claimed in claim 15, further comprising comparing the sounds emitted with a database of sounds made by springs in tools having actuation springs; and
generating an estimated condition of the spring based upon the comparing.

18. The method as claimed in claim 15, further including moving an acoustic sensor into acoustic proximity with the spring.

19. The method as claimed in claim 18 wherein the moving is running the acoustic sensor in a borehole.

20. The method as claimed in claim 17, further including operating an artificial intelligence processor to support the comparing.

21. The method as claimed in claim 17, further including making a decision on when to replace or repair the tool based upon the generating.

22. A borehole system comprising:
a borehole in a subsurface formation;
a string in the borehole;
a spring actuated tool disposed within or as a part of the string;
a spring health monitor as claimed in claim 7 disposed in acoustic proximity with the spring of the tool.
